(19) United States
(12) Patent Application Publication
(10) Pub. No.: US 2002/0043144 A1
(43) Pub. Date: Apr. 18, 2002

(54) Method and device for forming a tear line in an airbag cover, and the cover thereof

(76) Inventors: Stefan Reh, Worth (DE); Konrad Sauer, Aschaffenburg (DE); Peter Roos, Sulzbach/Main (DE)

Correspondence Address: FOLEY & LARDNER, Wahington Harbour, Suite 500, 3000 K Street, N.W., Washington, DC, 20007-6140, US

(21) Appl. No.: 09/944,157

(22) Filed: Sep. 4, 2001

Related U.S. Application Data
(63) Continuation of application No. PCT/DE00/00554, filed on Feb. 22, 2000.

(30) Foreign Application Priority Data
Mar. 1, 1999 (DE) 199 10 141.8

(51) Int. Cl. B26D 3/08

(52) U.S. Cl. 83/881; 83/451

(57) ABSTRACT

A device and a method for forming a weakening area in an airbag cover having a support layer and a decorative layer over the support layer include a cutting support and a cutter. The support supports the airbag cover with the decorative layer side facing down and the cutter is displaceably positionable over the support. A tear line of a predetermined pattern is formed through the support layer and into the decorative layer with the cutter while controlling the depth of cut relative to the support to precisely control the residual thickness of the tear line and to prevent the cutter from penetrating through the decorative layer. The controller controllably displaces the cutter for precise controlled cut.

This is a continuation of International Application PCT/DE00/00554 having an international filing date of Feb. 22, 2000; this international application was not published in English, but in German, as WO 00/51851.

### BACKGROUND

Airbag units or modules, which contain a folded airbag and a gas generator, are typically installed under a dashboard cover, a steering-wheel center cover, a seat cover, or a door trim. The cover must be designed so that it does not substantially delay or impede the deployment of the airbag when the gas generator is activated. But the cover must also not impair the overall esthetics or functionality. In particular, it is desirable for the airbag unit to remain invisible to the passengers. But in many cases, elaborate flap or door mechanisms are used. But these mechanisms undesirably increase the costs of installing airbags without allowing freedom of design. In this respect, tear lines, which are advantageously cost effective, in the cover of the airbag unit have been devised. Tear lines can be formed in the trim of the passenger compartment of the vehicle, such as the steering-wheel center cover or the door trim, or in the airbag cover itself. Tear lines, which are weaknesses in the material, are designed to tear by the deploying airbag to form an aperture or door through which the airbag deploys.

There are many known methods of producing such tear lines. In general, they are produced by scoring or cutting the material. For example, European patent publication EP 0 646 499 B1 discloses a vehicle dashboard that has a rigid trim panel and a superposed layer of plastic foam with an outer skin. After the composite dashboard is formed, the inner and outer layers around the area covering the airbag are partly or completely cut through with a mechanical device or a laser, while maintaining the foam layer in tact. The cut is made at an angle so that the lid can withstand a stress from outside. A disadvantage of this tear edge is that the outer skin must not offer too great resistance to the tearing operation so that leather-covered covered dashboard cannot be produced this way, as no defined weakening of the outer skin is possible.

In this respect, European patent publication EP 0 749 872 A2 discloses an airbag cover having a decorative skin comprised of an outer layer and a barrier layer. While the decorative skin is heated, a depression is optionally made in the outer layer by vacuum forming, an inner layer is applied to the decorative skin, and a second depression is made in the inner layer. The inner layer is produced by injection molding. The depression is cut with an ultrasonic or high-frequency welding appliance, a heated knife, or a high-frequency cutter. This method, likewise, does not allow invisible weakened line and is therefore undesirably limited in respect of possible designs of the cover.

German patent publication DE 44 09 405 A1 discloses a method of forming an airbag cover having an inner molded layer of relatively rigid polymeric material and an outer layer of relatively soft polymeric material. A tear line is cut from the inner molded layer into the cover, so that the tear line penetrates completely through the inner molded layer. The tear line is cut in such a way that no pressure is exerted on the cover. Suitable cutting techniques include lasers, ultrasonic cutters, and heated cutters. These cutting techniques, however, generate heat, undesirably thermally stressing the cover. It is also difficult to monitor the depth of cut using these techniques.

Other methods also have been proposed where the decorative layer is cut separately from the inner layer or layers. The separations, as tear lines in the support layers, are in this case cut, in part, during its production by appropriate injection molds. Because of this separate provision of the tear lines in the parts of the cover, however, it is difficult to precisely align the individual parts of the cover relative to one another.

Accordingly, there is a need for a way of more easily and simply forming tear lines of defined depth of cut in airbag covers. The present invention addresses this need.

### SUMMARY OF THE INVENTION

The present invention relates to a method of and device for forming a weakening area in an airbag cover having a support layer and a decorative layer over the support layer, and an airbag formed by the present method or device.

One aspect of the present invention is the method, which includes providing a cutting support that supports the airbag and a cutter. The cover with the decorative layer is placed facing down on the support. A tear line of a predetermined pattern is cut through the support layer and into the decorative layer with the cutter while controlling the depth of cut relative to the support to precisely control the residual thickness of the tear line and to prevent the cutter from penetrating through the decorative layer.

During the cutting step, a predetermined force can be applied at least to the area of the cover being cut. The cutter can exert this predetermined force. Moreover, a vacuum can be applied to the cover to maintain this predetermined force against the support during the cutting step. In this respect, the support can have a plurality of apertures, and the device can include a vacuum generator in communication with the apertures for generating vacuum and maintaining the cover against the support.

Another aspect of the invention is the device, which comprises the cutting support, the cutter, and a controller. The support supports the airbag cover with the decorative layer side facing down and the cutter is displaceably positionable over the support. The controller displaces the cutter over the support for cutting a tear line of a predetermined pattern through the support layer and into the decorative layer with the cutter while controlling the depth of cut relative to the support to precisely control the residual thickness of the tear line and to prevent the cutter from penetrating through the decorative layer.

Another aspect of the invention is the cover made from the present method or device.

The cutter can be a blade, which can be oscillating type. The support layer can comprise a plastic and the decorative layer can comprise leather. The cover can further include an intermediate layer disposed between the support layer and the decorative layer. The intermediate layer can be a soft material selected from foamed plastic or an elastomer.

The depth of cut can vary along the tear line. A central region of the tear line can be cut deeper than at its ends. The depth of cut can decrease continuously from the center of the tear line to ends thereof. The tear line can be substantially H-shaped. The ends of the tear line can be cut in a semicircular shape. The tear line can also be cut with an undulating shape.

### BRIEF DESCRIPTION OF THE DRAWINGS

FIG. 1 schematically illustrates a device for cutting tear lines in an airbag cover.

FIG. 2 illustrates an underside of an airbag cover for a steering-wheel airbag unit illustrating substantially H-shaped tear lines.

FIG. 3 illustrates a cross section taken along line III-III of FIG. 2.

FIG. 4 is substantially identical to FIG. 2, but with a different tear lines.

FIG. 5 illustrates a cross-sectional view similar to FIG. 3, but showing an embodiment of an airbag cover made from foamed or monolithic plastic.

FIG. 6 illustrates a cross-sectional view similar to FIG. 5, but showing an embodiment of an airbag cover comprising a support layer and a decorative layer.

FIG. 7 illustrates a cross-sectional view similar to FIG. 5, but showing an embodiment of an airbag cover comprising a plastic support layer covered with leather.

FIG. 8 illustrates a cross-sectional view similar to FIG. 7, but showing an embodiment of an airbag cover comprising a plastic support layer, a padded intermediate layer, and a leather outer layer.

### DETAILED DESCRIPTION

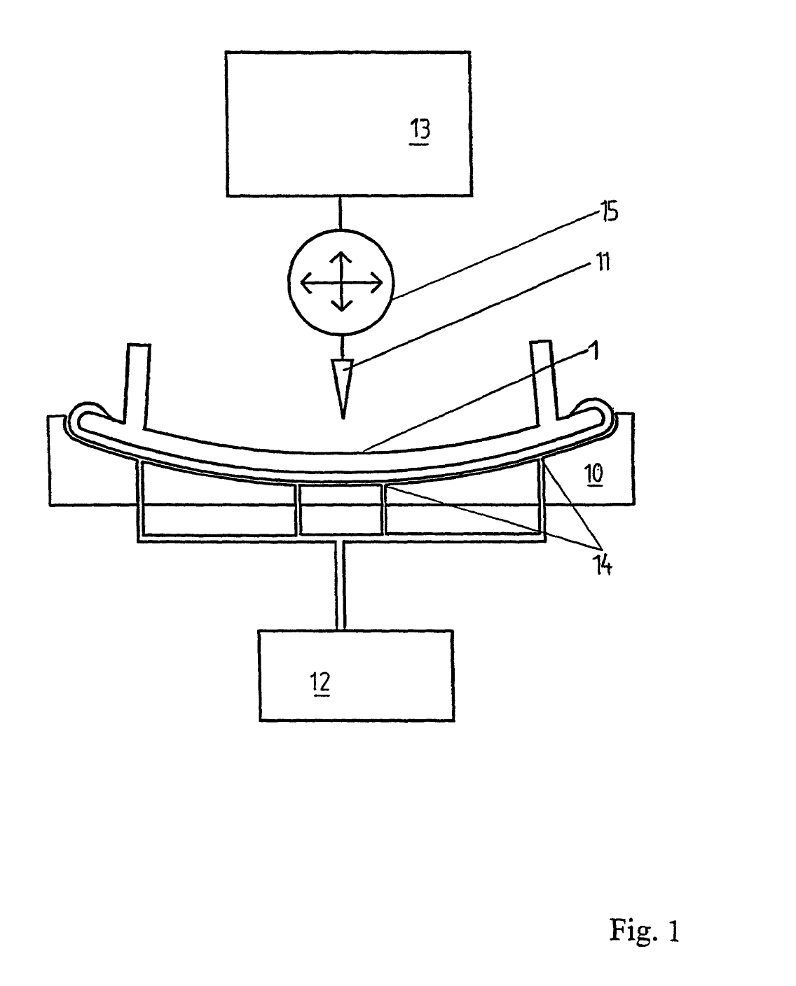

FIG. 1 schematically illustrates a device for forming tear lines in an airbag cover according to the present invention. The device, which can perform the method according to the invention, comprises a cutting receptacle or support 10 for receiving an airbag cover 1, a cutter 11, and a controller 13. The cutter 11 is displaceably and controllably mounted over the support 10 via a displacing mechanism 15, which is controllable with the controller 13. The controller detects the position and movement of the displacing mechanism, including the depth of cut in accordance with set predetermined parameters.

The cutter 11 can be a knife or blade, in particular, a scalpel-type blade. This makes it possible to cut the cover without inducing thermal stress, allowing cutting of coated or leather-clad airbag covers. The knife also avoids damaging or buckling of plastic material surrounding the cut, such as caused by burning or melting. In this respect, the cutter can be, after each cutting operation, monitored for changes in the blade geometry, as the blade geometry is critical to obtaining the precise cut depth. Alternatively, the blade geometry may also be monitored, for example, by test cuts. Furthermore, it is possible to detect changes in the blade geometry by monitoring the force applied to the cover using a sensor(s) on the cutter holder 15. The cutter also can be any known cutting device, such as for example a heated knife, ultrasonic knife, or laser. If the alternative cutting devices are used, the support can include a cooler to dissipate heat away from the cover 1 if heat sensitive materials are being cut.

The support 10 has a plurality of vacuum apertures 14 and a vacuum generator 12 communicating with the apertures 14. The apertures 14 also can have recessed or enlarged throat formed at the opening end so that they open into zones recessed somewhat relative to the outline of the receptacle 10, to increase the surface upon which the vacuum can act. The support can be produced by casting methods as a negative profile of the airbag cover, so that the outlines or profiles of the cover and the support match perfectly.

The airbag cover 1 can be fixed or secured to the support 10 by applying vacuum or negative pressure to one side of the cover 1 through the apertures 14. Alternatively, the pressure exerted by the cutter can be used to provide a predetermined force necessary to maintain the cover held against the contour of the support.

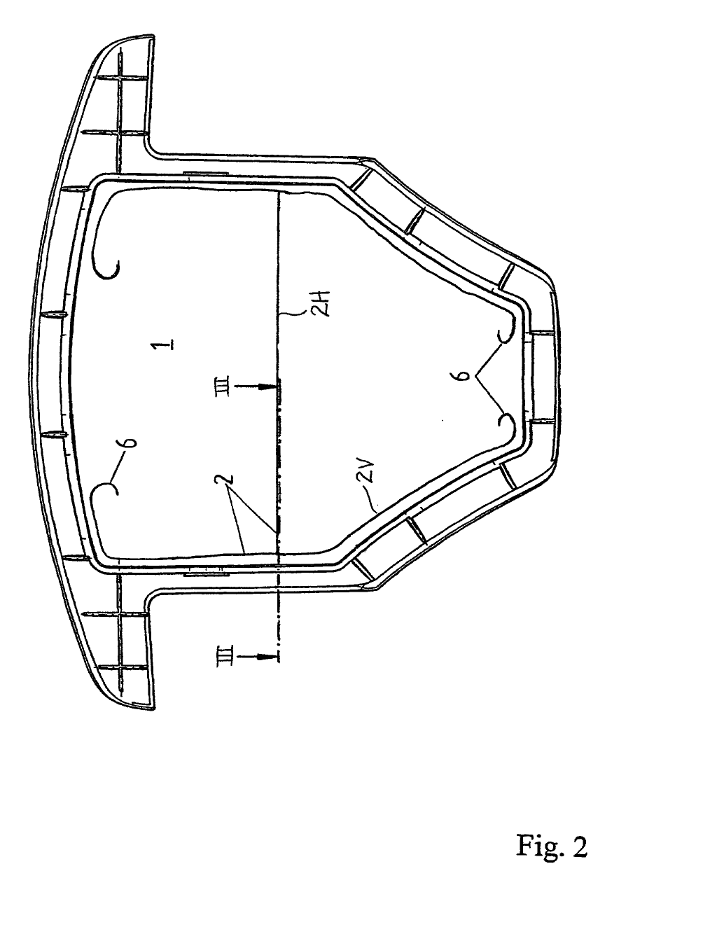

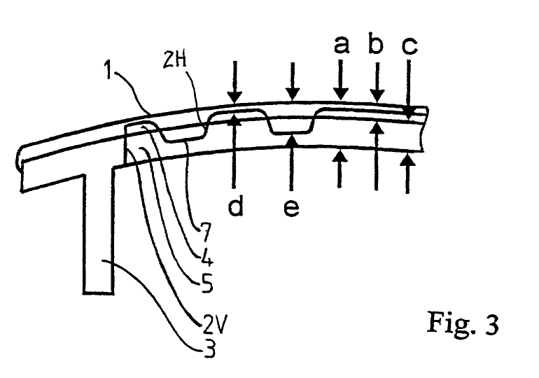

FIGS. 2 and 4 illustrate an underside of an airbag cover 1 produced according to the invention. The illustrated embodiment is a cover 1 adapted for a steering wheel airbag. The cover 1 can be molded from plastic, typically foamed plastic. Such a cover is typically 1.5 mm to 5.0 mm thick and is governed by the production technology. Referring to FIGS. 3 and 5-8, the cover 1 can further include fixing means 3, via which the cover can be secured, for example, to the steering wheel or to the airbag unit.

To form a tear line or lines, the cover 1 is then placed on the support 10, with the outer visible side facing down, and the entire cover or at least portion of the area being cut can be held to the support using vacuum, for example. Tear lines 2 are then cut into the plastic from the underside of the cover 1 with a knife, which can be a scalpel-type blade. The depth of cut of the tear lines 2 can be set, relative to defined points of the support 10 so that the residual thickness of the cover 1 (after the cut) is approximately 0.3 mm to 1.5 mm. The position or course of the tear lines 2 also can be set relative to the support 10.

The tear lines 2 typically has a substantially H-shaped pattern (substantially horizontal segment 2H ending with a pair of substantially opposite vertical segments 2V) so that during the airbag deployment, the cover 1 can swing open like a double swing door as soon as the cover 1 is torn along the tear lines 2. To avoid a complete tearing-away of the cover 1, which can result from uncontrolled further tearing, the substantially vertical segments can have semicircular endings 6, as illustrated in the embodiment of FIG. 2. FIG. 4 illustrates another tear line configuration. In this embodiment, the substantially horizontal segment of the tear lines has an undulating pattern. This tear line design increases stability against a stress pushing through the cover from outside.

FIG. 3 illustrates a sectional view taken along line III-III of FIG. 2, illustrating the substantially horizontal segment 2H of the tear lines 2. In this illustrated embodiment, the cover 1 has a support layer 5 having a thickness c and a decorative layer 4 having a thickness b. The total thickness of the cover 1 is a (b+c). The substantially horizontal segment 2H has portions that extend through the support layer 5 and into the decorative layer 4. Regardless of thickness fluctuations of the various layers, caused by material factors, the depth of cut can be controlled so that a constant residual depth d of the cover 1 results.

In this case, the depth of cut has additionally been varied along the substantially horizontal segment 2H so that webs 7 having a thickness e are formed. The webs 7 are thicker than the residual thickness d, but less than the total thickness a of the cover 1. Typical web thickness e is approximately 1.0 to 3.0 mm. The webs stabilize the cut regions relative to one another. Via the webs 7, the tearing performance along the tear line 2 can be selectively controlled. In this case, the webs 7 prevent the cover 1 from tearing in the region of the transition from the substantially horizontal segment to the substantially vertical segments.

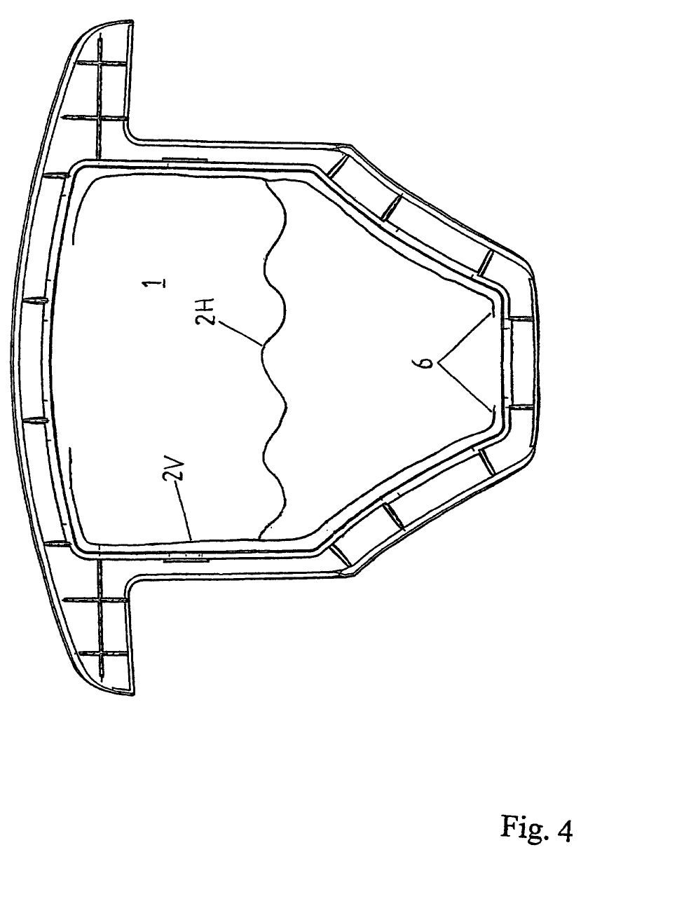

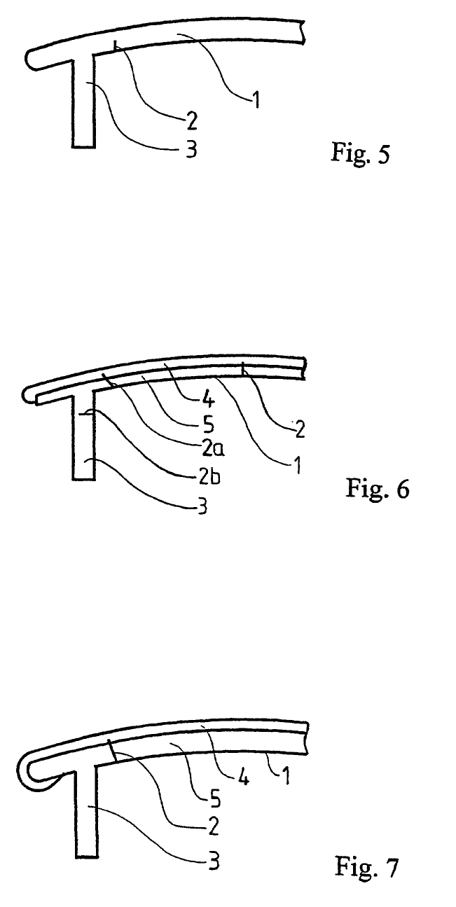

FIG. 5 illustrates a cross-sectional view of one type of a cover 1 for an airbag unit. Here, the cover 1 is produced integrally from foamed or injection-molded 1-component plastic. The thickness of the cover 1 is typically approximately 1.5 to 5.0 mm. The depth of cut of the tear lines 2 can be set so that the residual thickness of the cover is approximately 0.3 to 1.5 mm. The depth of cut can decrease to 0 mm from the center of the tear lines to their ends.

FIG. 6 illustrates a cross-sectional view of another type of a cover 1 for an airbag unit. Here, the cover comprises a decorative layer 4 and a support layer 5, similar to the embodiment of FIG. 3. Parts 2a of the tear lines can be cut into the cover 1 obliquely at an angle (other than 90° relative to the direction of extension of the cover). This design moves any force exerted on the surface of the cover 1 to the side and prevents pressing-in or inwardly collapsing of the cover 1. To improve stability, tear lines 2b may also can be provided in the fixing means 3 instead of obliquely cut tear lines 2a. The decorative layer 4 can be approximately 1.0 to 2.5 mm thick and the support layer 5 approximately 1.5 to 2.5 mm thick. The total thickness of the cover 1 can be in the range from 2.5 to 5.0 mm.

FIG. 7 illustrates a cross-sectional view of yet another type of a cover 1 for an airbag unit. The cover 1 is substantially similar to the embodiment of FIG. 6. Here, the decorative layer 4 can be leather, fabric, or film. The support layer 5 can be either plastic or foamed plastic. The decorative layer 4 can have a thickness of approximately 0.6 to 2.0 mm and the support layer 5 approximately 1.5 to 2.5 mm thick. The thickness of the cover 1 can be approximately 2.1 to 4.5 mm. The cover of this type can be produced in a single step using a conventional 2-component technique. The tear lines 2 are formned on only the portions where the support layer 5 is covered with the decorative layer 4.

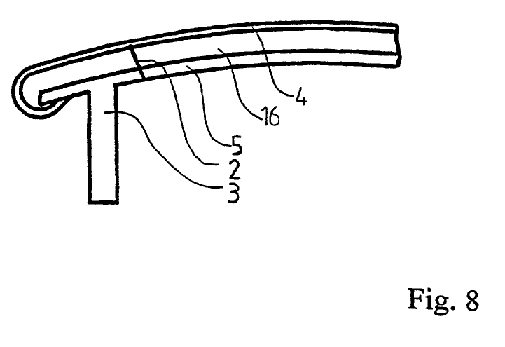

FIG. 8 illustrates a cross-sectional view of yet another type of a cover 1 for an airbag unit. The cover is substantially similar to the embodiment of FIG. 7, but provided with an intermediate layer 16 between the support layer 5 and the leather decorative layer 4. The intermediate layer 16 preferably comprises a foamed plastic, such as polyurethane, or elastomer and acts as a cushion. The intermediate layer 16 can be produced together with the support layer 5 using a conventional 2-component technique.

Covers of this type previously caused serious cutting problems; a defined weakening of the decorative layer of leather is difficult to cut through the support layer, and cutting through the intermediate layer was hardly possible. The present invention solves these problems by controlling the cutter relative to the cutting support. The tearing performance thus can be adapted to any particular requirements.

According to the invention, the depth of cut and the position of the cutter can be controlled relative to the support, not to the cover on the support. Controlling the depth of cut relative to the support ensures that, regardless of material tolerances of individual layers of the cover, a defined residual thickness of the cover is always achieved since the outer surface of the cover follows the contour of the support. The depth of cut thus can be controlled to vary along the course of the tear lines. For example, the depth of cut can be made greater at the center of a tear line than at its ends, toward which the cut depth falls continuously or abruptly to zero. As a result, the cover can tear easily and quickly when the airbag deploys, but the decreased depth of cut toward the ends prevents onward tearing beyond the ends of the tear line. The present invention allows a reliable depth of cut, because the cut is made relative to the support and not the cover. Accordingly, the present invention is suitable for leather-clad or otherwise covered airbag covers.

The controlled cut relative to the support also prevents undesirable penetration through the outer decorative layer. Penetrating through the outer decorative layer can weaken the cover too much, which can cause additional tearing of the cover during normal use. Tearing the cover prematurely before deploying the airbag can expose the airbag and can be detrimental to proper airbag deployment.

The number and shape or configuration of the tear lines likewise can be variably adjusted to specific needs. Thus, in addition to a single linear tear line, H-shaped or star-shaped tear lines can be formed, for example. The individual tear lines may follow any desired course, and arcs and curving lines can readily be produced. The cutter can be controlled using known means, such as programmable computers or logic device.

Moreover, the cuts or separations as such can be produced not only perpendicularly to the surface of the cover but also at any desired angle thereto. As a result, the tearing operation can be beneficially influenced by the angles of the cuts.

The tear lines are invisible to the passengers, as the cut edges immediately bear against one another. No waste is produced, nor are any waste gases generated, as occurs when cutting with a laser or heated knife, when a blade is used. Moreover, the blade reduces energy consumption during formation of tear lines.

The present invention allows the material and design of the cover to be varied substantially at will. The cover may, for example, be produced from a plastic that may optionally be foamed. Customarily, the design of the cover is governed by the design of the remainder of the passenger compartment and is adapted to it. Because of the gentle cutting techniques usable according to the present invention, no restrictions exist in this respect regarding the materials to be cut.

The present invention allows cost-effective and timesaving production of tear lines. The tear line cutting device and method according to the present invention allow fully automatic and precise production of tear lines in an airbag cover. The device can be rapidly adapted to different covers by simply changing the support.

The disclosures of the parent application, PCT/DE00/00554, and its priority application, DE 199 10 141.8, in their entirety, including the drawings, claims, and the specification thereof, are incorporated herein by reference.

We claim:

1. A method of forming a weakening area in an airbag cover having a support layer and a decorative layer over the support layer, comprising the steps of:
providing a cutting support that supports the airbag;
providing a cutter;
placing the airbag cover with the decorative layer facing down on the support; and
cutting a tear line of a predetermined pattern through the support layer and into the decorative layer with the cutter while controlling the depth of cut relative to the support to precisely control the residual thickness of the tear line and to prevent the cutter from penetrating through the decorative layer.

2. A method according to claim 1, further including the step of applying a predetermined force at least to the area of the cover being cut during the cutting step.

3. A method according to claim 2, wherein the cutter exerts the predetermined force on the cover during the cutting step.

4. A method according to claim 1, further including the step of maintaining at least to the area of the cover being cut against the support during the cutting step with vacuum.

5. A method according to claim 1, wherein the cutter is an oscillating cutter.

6. A method according to claim 1, wherein the cutter is a blade.

7. A method according to claim 1, wherein the support layer comprises a plastic.

8. A method according to claim 1, wherein the decorative layer comprises leather.

9. A method according to claim 1, wherein the support layer comprises a thermoplastic elastomer and the decorative layer comprises leather.

10. A method according to claim 1, wherein the cover further includes an intermediate layer disposed between the support layer and the decorative layer.

11. A method according to claim 10, wherein the intermediate layer comprises a soft material selected from foamed plastic or an elastomer.

12. A method according to claim 1, wherein the depth of cut varies along the tear line.

13. A method according to claim 11, wherein the cutting step includes cutting deeper at a central region of the tear line than at ends thereof.

14. A method according to claim 11, wherein the cutting step includes decreasing the depth of cut continuously from the center of the tear line to ends thereof.

15. A method according to claim 1, wherein the tear line is substantially H-shaped.

16. A method according to claim 15, wherein the ends of the tear line are cut in a semicircular shape.

17. A method according to claim 1, wherein the tear line is cut with an undulating shape.

18. A device for forming a weakening area in an airbag cover having a support layer and a decorative layer over the support layer, comprising:
a cutting support for supporting the airbag cover with the decorative layer side facing down;
a cutter displaceably positionable over the cutting support;
a controller for displacing the cutter over the support for cutting a tear line of a predetermined pattern through the support layer and into the decorative layer with the cutter while controlling the depth of cut relative to the support to precisely control the residual thickness of the tear line and to prevent the cutter from penetrating through the decorative layer.

19. A device according to claim 18, wherein the cutter is a blade.

20. A device according to claim 19, wherein the support has a plurality of apertures, and further includes a vacuum generator in communication with the apertures for generating vacuum and maintaining the cover against the support.

21. An airbag cover formed by the method of claim 1.

22. An airbag cover formed by the device of claim 18.
